(19) United States
(12) Patent Application Publication
(10) Pub. No.: US 2005/0177463 A1
(43) Pub. Date: Aug. 11, 2005

(54) Virtual showroom for interactive electronic shopping

(76) Inventors: William G. Crutchfield JR., Charlottesville, VA (US); Jefferson W. Doner, Earlysville, VA (US)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 11/053,931

(22) Filed: Feb. 10, 2005

Related U.S. Application Data
(60) Provisional application No. 60/542,856, filed on Feb. 10, 2004.

(51) Int. Cl. G06F 17/60

(52) U.S. Cl. 705/27

(57) ABSTRACT

A system and method for providing a virtual showroom for interactive electronic shopping is provided. A display terminal located inside a merchant store displays a virtual store that has a physical layout corresponding to the physical layout of the real store. The terminal receives input from a shopper and outputs shopping information based on the input. The display terminal may also allow the shopper to browse products and virtually travel through the virtual store in a manner similar to physically shopping in the real store.

### RELATED APPLICATIONS

This application claims priority to U.S. Provisional Application No. 60/542,856, filed Feb. 10, 2004, which is incorporated herein by reference in its entirety. This application is related to U.S. application Ser. No. 10/147,476 filed on May 16, 2002, which is also incorporated herein by reference in its entirety.

### FIELD OF THE INVENTION

This invention relates generally to interactive display systems and methods. More particularly, but not by way of limitation, this invention relates to such systems and methods utilizing a computer terminal so that an individual shopper can access product and merchant information from a display terminal inside a merchant store.

### BACKGROUND OF THE INVENTION

Commercial use of computer terminals allows shoppers to investigate and purchase products offered for sale. Typically, shoppers use computers for shopping purposes when they are not physically present in the store. For instance, they shop online from their home computer.

For example, U.S. Pat. No. 6,026,376 to Kenney (“Kenney”) provides an interactive electronic shopping system wherein shoppers can use their personal computers to virtually shop in a virtual merchant store whose layout corresponds to a real physical merchant store, such as a grocery store or restaurant. The disclosure of Kenney is incorporated herein by reference in its entirety. The virtual store is created by converting video images of a real store into digital information that can be transmitted to a shopper at the shopper's home or office computer. By navigating through the virtual store, shoppers can virtually shop in a manner similar to how they would shop at the real store. For instance, shoppers can virtually travel down aisles with a virtual shopping basket or cart and view images of the aisles and products as they are actually displayed in the real merchant store. The shopper can also organize shopping information, such as by creating a list of products selected while virtually shopping. The system disclosed in Kenney is limited to so-called online shopping where the consumer is experiencing the virtual store on his/her computer at home away from the physical store.

One disadvantage of systems like Kenney is that when the consumer later travels to the actual store, he/she may not recall certain store layout and store navigation information gathered when he/she was virtually shopping at home.

Another disadvantage of Kenney is that the consumer at home cannot readily examine the actual products which are located at the actual store. Another disadvantage of Kenney is that Kenney's virtual store provides no mechanism for demonstrating product performance. Kenney merely discloses providing descriptions and pictures of the product.

There presently exists a need for a video-based interactive electronic shopping system which allows a customer to view the contents of a particular shopping facility in a format that simulates the experience of shopping in that particular facility while a shopper is shopping at the facility. Use of the system should be available at the merchant store through a merchant computer terminal.

### OBJECTS OF THE INVENTION

It is an object of the invention to enable a shopper to see a virtual reproduction of an actual store while the shopper is inside the store. Shoppers could more easily remember product location information in a shopper's short-term memory than in the prior art, which required a shopper to remember a product's location long after viewing a virtual layout of the store. Convenience would also be enhanced if the shopper could locate and examine representations of the products at a computer terminal at the store in a manner similar to how one would locate and examine their physical counterparts at the actual store.

It is a further object of the invention to enable shoppers to create one or more lists of what the shopper may need to buy during a virtual shopping experience at the store based upon historical or predetermined ordering patterns or upon actual selections at the time the shopper is virtually shopping.

It is a further object of the invention to monitor and analyze customer behaviors during a virtual shopping experience inside the store. The store can use such information to improve its product selection, product placement, promotions, inventory, and other store features and management issues, leading to greater profitability and a more effective shopper experience.

It is a further object of the invention to enable a shopper to experience the look, feel, and performance of a plurality of products, such as audio or video output devices, at a single location of the terminal rather than at multiple product locations throughout the store. Further convenience would be added by providing a reference audio-visual system for simulating the performance characteristics of audio-visual products at a computer terminal. This would enable consumers to test a variety of audio-visual products at a single location. It would further enable merchants to provide a single demonstration system rather than providing a demonstration for each audio-visual product in the store.

### BRIEF SUMMARY OF THE INVENTION

According to an embodiment of the invention, an interactive electronic shopping system is provided. A terminal located inside a physical merchant store comprises an input device for receiving shopper input. The terminal also comprises an output device for displaying a virtual merchant store. The virtual merchant store corresponds to the physical layout of the physical merchant store.

According to another embodiment of the invention, a method of displaying a virtual store is provided. A virtual physical layout of a physical merchant store is displayed at a display terminal located inside the physical merchant store, wherein the virtual physical layout corresponds to the real physical layout of the physical merchant store. Input is received from a shopper at the display terminal. Shopping information is output at the display terminal, wherein the shopping information is based on the input.

According to another embodiment of the invention, an interactive electronic shopping system is provided. A central database stores digital signals representing images of at least a portion of a shopping facility. A computer terminal at the shopping facility comprises a display device configured to display images of the shopping facility. A communication link links the central database and the computer terminal. A control interface connected to the computer terminal enables a shopper to control a display of the images of the shopping facility.

According to another embodiment of the invention, a method of displaying a virtual store is provided. A virtual physical layout of a physical merchant store is displayed at a display terminal located inside the physical merchant store. The virtual physical layout corresponds to the real physical layout of the physical merchant store. The virtual physical layout comprises a virtual terminal corresponding to the display terminal. Shopper browsing information is received from a shopper at an input device electronically coupled to the display terminal. The shopper browsing information is associated with virtual movement through the virtual physical layout that corresponds to movement through the physical merchant store. Based on the shopping information, a substantially continuous stream of images showing virtual movement from one location in the virtual store corresponding to a physical location in the physical merchant store to another location in the virtual store corresponding to another location in the physical merchant store is displayed at the display terminal. A plurality of virtual products associated with a virtual location in the virtual physical layout corresponding, respectively, to a plurality of physical products located in the physical merchant store is displayed at the display terminal. A selection of a specific one of the plurality of products is received from the shopper. Product information associated with the selected product is passed to the shopper. Product location information indicative of a location of the selected specific product in the physical merchant store is passed to the shopper.

Other embodiments could be considered.

### DESCRIPTION OF THE DRAWINGS

FIG. 1 illustrates a typical prior art merchant store layout.

FIG. 2 illustrates a typical prior art merchant shelf.

FIG. 3 illustrates a communication system according to an embodiment of the invention.

FIG. 4 illustrates a terminal according to an embodiment of the invention.

FIG. 5 illustrates a virtual showroom according to an embodiment of the invention.

FIG. 6 illustrates a product shelf in a merchant store according to an embodiment of the invention.

FIG. 7 illustrates a sample image or graphic displayed at a terminal according to an embodiment of the invention.

FIG. 8 shows a flow chart illustrating an exemplary method of enabling interactive shopping at a merchant terminal according to an embodiment of the invention.

FIG. 9 shows a flow chart illustrating a method of enabling interactive shopping at a merchant terminal according to another embodiment of the invention.

### DETAILED DESCRIPTION OF THE DRAWINGS

The present invention provides a novel interactive electronic shopping system and method that makes shopping more convenient for a shopper who is shopping at a merchant shopping facility. Using the invention, a shopper at a merchant store can use a computer terminal to browse through a virtual representation of the store in a manner similar to shopping in the actual store itself. The shopper can search for products, examine individual products, evaluate a simulated performance of a product, and select products for purchase. Through the selection process, one or more types of lists can be created, such as a list of products accumulated in a virtual shopping cart. Historical lists based on past ordering and predetermined buying frequency can also be provided to the shopper. Special displays or information can also be provided to alert the shopper to specials on particular products. Products can be located through a directory that correlates all the products with their actual locations in the store. Changes at the actual store can be implemented so as to be reflected in the virtual store.

The invention benefits customers because it provides the speed and convenience of online shopping with the advantages of a brick and mortar store that contains the physical products themselves. For instance, after shoppers arrive at a merchant store, shoppers may reduce shopping time by determining the location of a desired product at a shopping terminal rather than by wandering through the store and asking store employees for information. The invention also enables shoppers to obtain more product information than is typically available at a merchant store, and to obtain it more quickly. The invention may also permit shoppers to experience a simulated performance of one or more products, allowing shoppers to compare and contrast competing products. For instance, shoppers may make more accurate comparisons of a plurality of products by evaluating them in a simulated side-by-side demonstration, instead of comparing products located in different parts of a conventional store, usually without demonstration. The invention also enables a more streamlined purchase process at stores.

The invention benefits the merchant because, for example, it allows for customer loyalty to be developed since the virtual depiction of the merchant's store actually enables the customer to become familiar with the actual store and its particular products and also to stay abreast of changes. The invention enhances a merchant's customer service and saves costs. The invention provides an alternate way for shoppers to locate, examine, and purchase products. The invention also provides a faster and less costly method of updating product and store information. Changes may be updated in the virtual store instantly and automatically, which is an advantage over the substantial time and resources required to update price, promotions, and information tags on conventional shelves in conventional stores. While “digitizing” the shopping experience in many respects, the invention maintains several desirable features of brick and mortar shopping. While online shoppers are more likely to target and buy a specific product (i.e., they already know what they want), brick and mortar shoppers are relatively more likely to see and purchase items they did not originally intend to purchase. This is partly because they see the products on the shelves and on display, and this feature is preserved in the virtual shopping experience of the invention. This is a significant advantage to both merchants (who see increased sales volume) and consumers (who make better informed purchase decisions in less time).

According to an embodiment of the invention, a system for providing a virtual showroom for interactive electronic shopping is provided. A display terminal located inside a merchant store displays a virtual store that has a physical layout corresponding to the physical layout of the real store. The terminal receives input from a shopper and outputs shopping information based on the input. The display terminal may also allow the shopper to browse products and virtually travel through the virtual store in a manner similar to physically shopping in the real store.

According to an embodiment of the invention, a method for providing a virtual showroom for interactive electronic shopping is provided. A display terminal located inside a merchant store displays a virtual store that has a physical layout corresponding to the physical layout of the real store. The terminal receives input from a shopper and outputs shopping information based on the input. The display terminal may also allow the shopper to browse products and virtually travel through the virtual store in a manner similar to physically shopping in the real store.

An interactive electronic shopping system of the present invention comprises: means for creating a video representation of a shopping facility as would be seen by a shopper at a physical embodiment of the shopping facility; means for displaying a video representation of the shopping facility, wherein said means for displaying is located in the shopping facility; and control means for a shopper in the shopping facility to control the means for displaying such that the means for displaying causes the displayed video representation to change at the shopper's command to correspond to what the shopper would see were the shopper to move through a physical embodiment of the shopping facility.

In a particular implementation, the interactive electronic shopping system of the present invention comprises: a digital camera to digitize a shopping facility into digital signals representing images of the shopping facility, or a computer software generated simulation (e.g., graphics) simulating the shopping facility; a central database to store the digital signals and/or software simulation; a communication link between the central database and a computer terminal at the shopping facility; and a control interface connected to the computer terminal to enable a shopper to control the display of the computer terminal.

The present invention also provides a method of creating a virtual shopping facility for interactive shopping by computer. This method comprises: converting images of at least a portion of a shopping facility and a plurality of products therein into encoded digital signals; storing the encoded digital signals in a computer storage medium; and providing access to the stored encoded digital signals such that portions of the stored encoded digital signals are selectable and transmissible to a computer for displaying, on a monitor of the computer, virtual movement within a visual representation of the shopping facility and for permitting examination of visual representations of selected products in response to selected digital signals.

It is a general object of the present invention to provide a novel and improved interactive electronic shopping system and method. Other and further objects, features and advantages of the present invention will be readily apparent to those skilled in the art when the following description of the preferred embodiments is read in conjunction with the accompanying drawings.

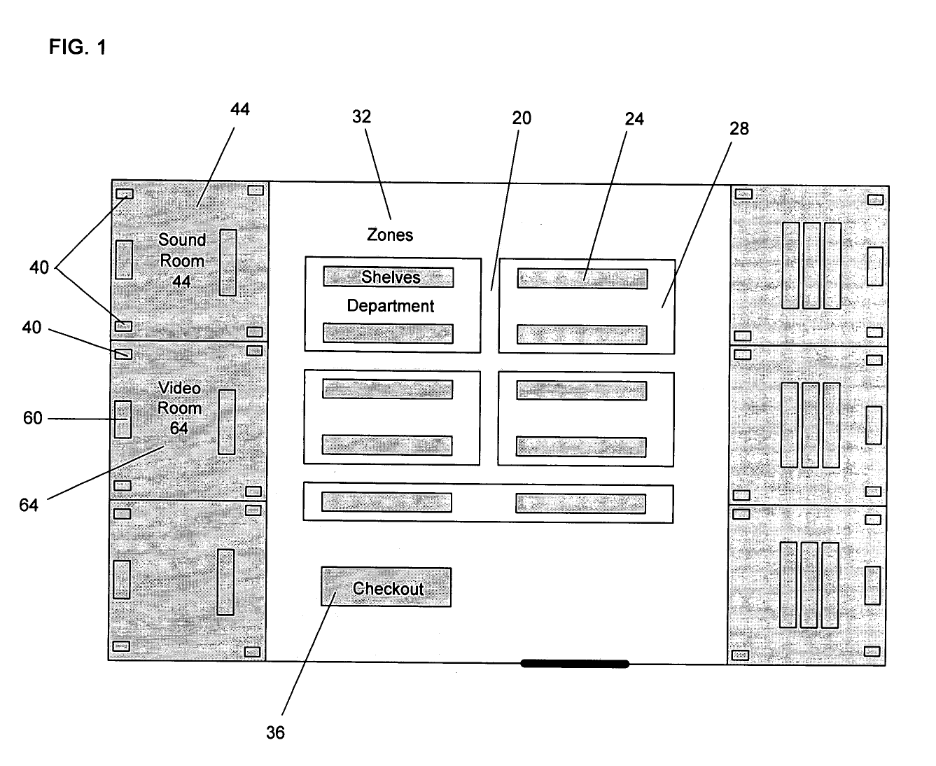

FIG. 1 illustrates a typical merchant store layout 1 for a consumer electronics store according to the prior art. The view is top-down. The merchant store layout may comprise aisles 20, shelves 24, a sound room 44 comprising speakers 40 offered for sale, a video room 64 comprising video devices 60 offered for sale, a checkout counter 36 for purchasing products, and departments 28 that group products together by product type (e.g., video or audio). Products may be further organized by zone (a group of related departments, such as zone 32 in FIG. 1) and section (a group of product types, such as TVs and DVD players). Each of these items and their uses are well-known in the art.

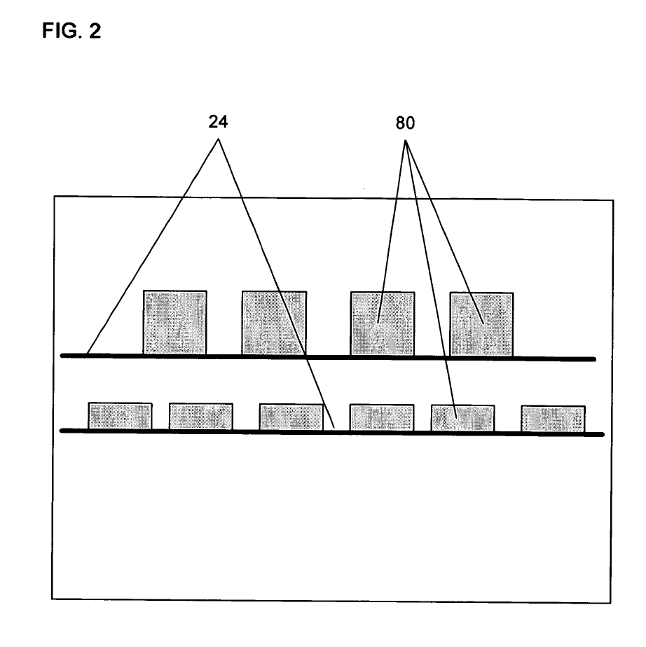

FIG. 2 illustrates a typical merchant shelf according to the prior art. Products 80 offered for purchase rest on shelves 24 in a merchant store. The shelves 24 may align either side of a merchant aisle 10. Customers may walk through the aisles 20 and inspect the products 80 on the shelves 24 of an aisle 10. Many different products 80 may be presented in a row on a shelf 24, and products 80 are typically grouped by product type or department in a particular area of the store. Additional information such as the product's 80 price, SKU, and other indicia or information may be present on or near the product. The practice of displaying products on merchant shelves is well-known in the art.

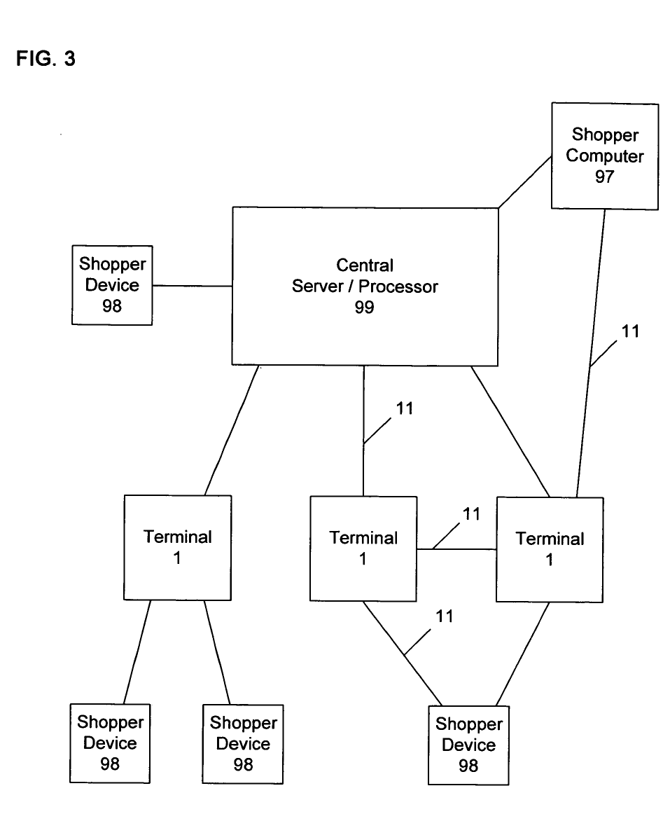

FIGS. 3-8 illustrate an advance over the prior art approaches depicted in FIGS. 1-2, according to various embodiments of the invention.

FIG. 3 illustrates a communication system according to the present invention. The system comprises a central processor or server 99, terminals 1, shopper devices 98, and shopper remote computers 97. The terminals 1 are located inside one or more merchant stores, while the central processor or server 99 may be located inside a merchant store or elsewhere. The shopper remote computers may access the terminals 1 or server 99 remotely, such as at a shopper's home or office.

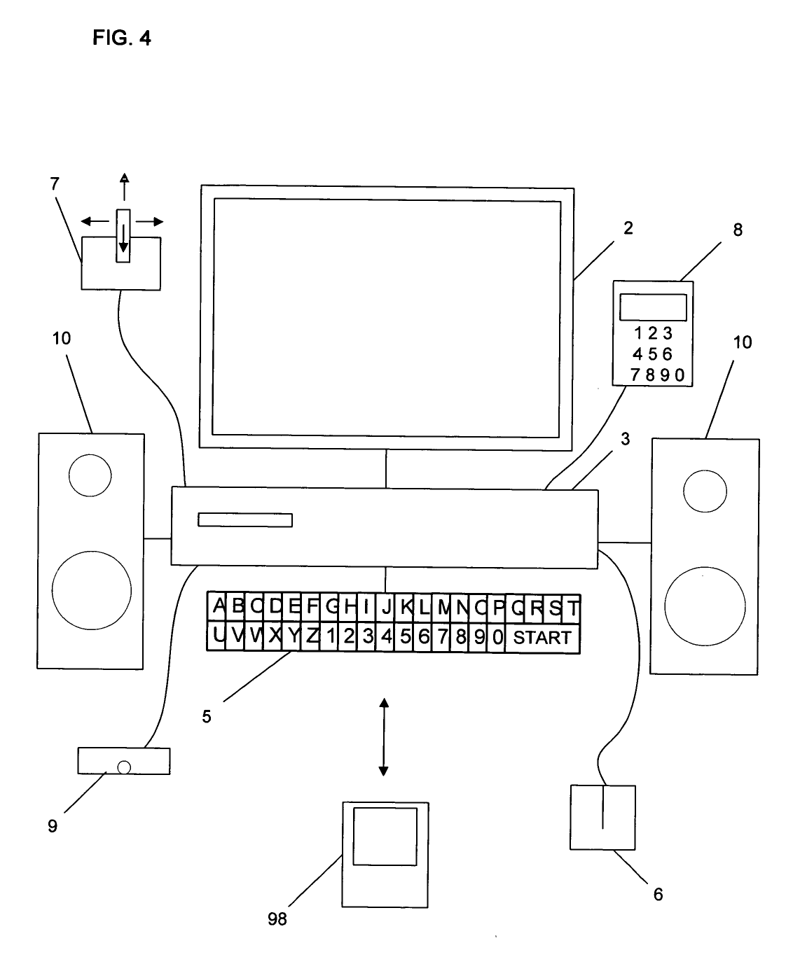

The terminal 1 may comprise a computer terminal 1 at a merchant store. The terminal 1 may be implemented as a kiosk device at a merchant store. The terminal 1 communicates with the central server 99 and outputs audio and video information to shoppers. The term “video” is intended here to encompass still images, movie images, as well as computer graphics information. The terminal 1 is described further in FIG. 4.

The central server 99 may store merchant shopping facility information, such as video (or graphics) information corresponding to the layout of the merchant store, product information, current sales, etc. The video information may comprise a comprehensive set of images (or graphics) of the shopping facility, aisles, shelves products, etc., such as images of products taken by a digital camera or graphics generated in a computer. The video information may also comprise a software program capable of generating a computer simulation of these images. This information may be stored additionally (or instead) at the terminal 1. This information may be used to display a virtual representation of the store at the terminals 1.

The virtual store can be digitally created in a number of different ways. For example, digital cameras can be used to capture image information of a merchant store, aisles, shelves, products, etc. These images can be stored in a database, for instance a database at a central server 99 or at the terminals 1 themselves. New images can be uploaded to the system whenever the corresponding component of the store changes, for instance when products are rearranged on shelves or new products are placed on the shelves. In one embodiment, a terminal 1 is configured to display a continuous stream of these images stored at the central processor 99 in order to simulate the actual shopping experience. For instance, the terminal 1 may display a stream of images similar to video footage of walking through the merchant store. Alternately, the terminal 1 may present a more static presentation whereby user command (i.e., input) causes the display screen to move from discrete image to discrete image, or from discrete computer graphic to the next computer graphic.

In another embodiment of the invention, a computer program creates a virtual representation of the store, either with or without the aid of actual images of the real store and products. The computer program may comprise a graphics engine for rendering streaming images of computer constructs (such as polygons and textures that simulate shelves and products). Such graphics engines are used widely in video games. For instance, the terminal's computer 3 (see FIG. 4) may be programmed to use the Source graphics engine developed for the game Half-Life 2, which uses a first-person perspective. Alternately, the terminal 1 may use the graphics engine used in the game Jedi Knight 2: Jedi Outcast, which can transition between third-person over-the-shoulder views and first-person views. The terminal computer 3 may also be programmed to use a graphics engine such as that used in Baldur's Gate Dark Alliance, which can seemlessly transition between top-down and first-person views. A graphics engine similar to that used in Baldur's Gate Dark Alliance may be particularly situated for switching from a substantially top-down view of a store to a first-person view of shelves and products. This would allow the shopper to smoothly zoom in from a top-down view of the store to a close-up first-person view of an aisle or product (and also switch back to a top-down view), thereby emphasizing the location of the product or aisle in the store and preserving the continuity of the virtual shopping experience. These source technologies for implementing the virtual store are exemplary only. One of ordinary skill will recognize that there are many other suitable graphics generation technologies that could be employed.

Similarly, movement through the virtual store may be accomplished in any manner used in any video game, such as a video game listed above. For instance, mouse, keyboard, and joystick controls may be used to control the movement, location, and viewing perspective of a view of the virtual store or a view of a virtual shopper within the virtual store.

The information stored at the central processor 99 may be updated at a terminal 1 as the information changes, such as when new products 80 are added or existing products 80 are moved. The central server 99 may be located in the store where the terminals 1 reside, or it may be located elsewhere. For instance, the merchant may have a central server in a location remote from merchant stores.

The central server 99 may communicate with the terminal 1 as well as a plurality of other terminals 1 located at the store (or located at other stores). For instance, terminals 1 at one merchant store may communicate with terminals 1 at another merchant store. In this way, shoppers may virtually shop at more than one merchant store while being in a single store. This enables shoppers to find products that may be in stock at one merchant store but not in stock at another.

The shopper devices 98 may comprise handheld display devices such as PDA, mobile phones, or any other portable wireless device. These devices may communicate with a terminal 1 or the central server 99. The shopper devices may access the terminal 1 or central server 99 via modem, cellular frequency, PDA frequency, or any other means by which a PDA, mobile phone, or wireless device may communicate with another computer. For instance, a shopper may log onto the Internet via a handheld device 98 and then access the central server 99 at a merchant Internet site. The shopper could then conduct virtual shopping activities on the handheld display device 98 and control the shopping experience using the inputs of the handheld device 98. Thus, the consumer could access the virtual store of the present invention without being at the terminals 1.

Similarly, a remote shopper (e.g., a shopper at home or at work) could use a remote computer 97 to access the central server 99 or a terminal 1 over the Internet.

Each terminal 1 may also communicate with one or more shopper devices 98, and a shopper device 98 may communicate with more than one terminal 1.

The communication between and among the terminals 1, shopper devices 98, and central server 99 may be via the network interface 11 or via any other communication means known in the art. For instance, the shopper devices 98 may communicate via wireless modems inside the shopper devices 98 or via cellular communication service. Network interface 11 can be any suitable network, such as a LAN, WAN, MAN, the Internet, or any other networked system.

FIG. 4 shows a terminal 1 according to an embodiment of the invention. The terminal may comprise a display 2, a computer 3, one or more input devices 5-9, one or more output devices 6-8, a processor 9, and a network interface (not shown). The display 2 displays images to a shopper.

The display 2 may comprise any visual display device, such as a computer monitor, LCD screen, plasma screen, a touch-screen such as that used in a Palm Pilot™ or Tablet PC™, projector (and screen), or a television. Some of these displays 2 may comprise their own input devices such that the user can enter commands/selections by touching the screen. In a preferred embodiment, the terminal 1 comprises a computer 3 connected to a thin flat-screen touch display 2.

The input devices 5-9 receive input. The input may be received from a shopper. Input may also be received from a merchant representative, a merchant server, or from another terminal 1. The input devices 5-9 may comprise any device used to capture input from a user, such as a mouse 6, keyboard 5, touchpad, pointing stick, joystick 7, trackball, button, motion detector, microphone (wherein the terminal 1 is configured to process voice input, such as via voice recognition technology), and/or touch-sensitive pad. Input devices may also comprise shopper devices 98 (see FIG. 3) such as PDAs, mobile phones, wireless devices, and handheld computers. For instance, the terminal 1 may transmit images to a PDA, and the shopper may navigate using the inputs on the PDA. As mentioned above, in a preferred embodiment, a touch-sensitive display 2 is used to capture shopper input.

The input devices 5-9 may receive input via any means known in the art. For instance, shoppers may use the mouse 6 and keyboard 5 to navigate the display 2 interface by typing commands and moving a cursor over icons and selecting them, as with a regular computer. Joysticks 7 and other input devices could be used to control the display 2 interface in a manner similar to methods used in video games. For instance, as garners control the movement of an avatar in a third-person perspective video game world, so a shopper may control the movement of a shopping avatar through a virtual merchant store.

A credit card input device 8 may swipe or otherwise receive credit card or other card information (such as a registration/membership card that enables registered members to begin a virtual shopping session). Such input device 8 may comprise a point-of-sale (POS) or other card reader device, well known in the art. Similarly, a barcode scanner 9 may receive product information, card information, or other identification information, for instance for the purpose of identifying products during purchase.

In addition to (or instead of) bar code scanner 9, there could be a transponder reader for reading transponder-triggered items, such as a user's transponder card, a key fob (or other authentication device), or products tagged with transponder-readable information. Shoppers may swipe their credit cards at a credit card input device 8 in order to purchase a product, to identify themselves when first accessing the virtual store, or both. The bar code scanner can be used to scan and/or read information, such as product barcodes, coupons, rebates, or other items that may be identified by a barcode. The transponder reader can be used to allow a consumer to purchase a product (e.g., using credit or other account information stored on the transponder card or elsewhere, to identify the consumer when first accessing the virtual store, or both. Other technologies for identifying, locating, and/or authenticating items or identities may also be considered.

The input received at the input devices 5-9 may comprise any customer input. For instance, customers may input their credit card numbers to purchase a product. Customers may also access the Internet at the terminal 1 and make any Internet-related inputs. Merchant representatives may also use the input devices 5-9 to perform maintenance on the terminals and update software, update product offerings or product locations, etc.

The output devices 6-8 output information to a shopper (or store representative) in addition to the output provided via the video display 2. Output information may comprise any product, store, or other shopping information. For instance, the information may comprise product descriptions, product specifications, pricing information, availability (in the merchant store or other merchant stores), special offers, product location information, store layout information, other useful shopping information, special offer/sale information, or other information that may be provided to a shopper. The information contemplated herein may comprise any information generally provided by merchants to potential customers (via mail, Internet, in-store, etc.).

The terminal speakers 10 may output audio information. For instance, the speakers 10 may output a recorded (or computer-simulated) voice that relates product information or any of the other types of information discussed above. The audio information may comprise audio demonstrations of products. For instance, the audio information may comprise a portion of a song, soundtrack, movie, or other audio entertainment, or the audio information may comprise a simulation of the performance of an audio product, such as a speaker, amplifier, CD player, DVD player, gaming console, or other audio player, etc.

A printer 8 may output information to the shopper. For instance, the printer may print a map showing the locations inside the store of products, shelves, aisles, departments, or zones selected by the shopper at the terminal. The information may also comprise product information, other product location information, special offers, coupons, receipts for payment, or other shopping information.

For instance, the shopper may purchase a product (such as a television) at the terminal (e.g., via the credit card input device) or at home (e.g., via a merchant website). The printer 8 may print the product receipt at the terminal printer 8. The shopper could then bring the product slip to a merchant counter, where the merchant would deliver the physical product to the customer, completing the fulfillment process.

The network interface 11 (FIG. 3) enables the terminal to communicate with another computer or server such as a central merchant server 99, another terminal 1, the Internet, and/or a shopper handheld device 98. The network interface 11 may comprise any means of connecting a computer to another computer or network, which are well-known in the art. For instance, the network interface may comprise a modem, wired or wireless ethernet connection, T1 connection, and any of the various networks previously discussed.

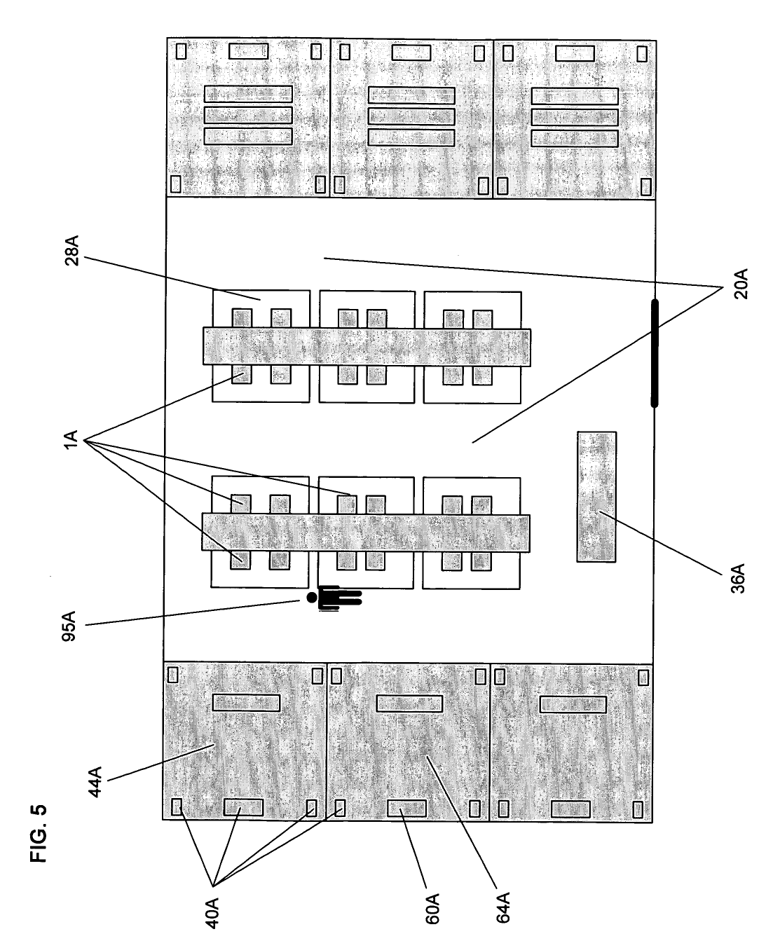

FIG. 5 illustrates an image (e.g., a dedicated video image or computer generated graphic) of a virtual showroom according to the present invention. The image may be shown to a shopper on the display 2 of the terminal 1.

The image of FIG. 5 shows the various store components, such as: terminal images 1A, department images 28A, aisle images 20A, checkout counter images 36A, sound room images 44A, speaker images 40A, video room images 64A, and video device images 60A. Each of these images may be selectable. For instance, a shopper may touch (or use a mouse or other input means to select) the image on the screen to show a closer view of that part of the store. For instance, the shopper may touch the image of the sound room 44A, and in response the display may switch to a new image 44A from inside the sound room 44. This new view may show a plurality of speaker images 40A that correspond to the layout of real speakers 40 inside the real sound room 44. The shopper could then touch the image of a particular speaker 40A in order to obtain additional information about that speaker, such as additional product views and pricing information.

In one embodiment, selecting a specific product 80, such as a speaker 40, enables a product demonstration wherein the terminal 1 simulates the performance of the selected product 80. For instance, if a shopper selects a speaker 40 (or set of speakers), the terminal 1 may output an audio signal (such as a soundtrack) at the terminal's speaker(s) 10 that simulates the audio performance characteristics of the selected speaker(s) 40.

The shopper may make inputs at the terminal 1 to vary the demonstration of the product 80. In other words, the shopper may inspect the performance of the product in a manner similar to how a shopper might inspect the real product at a real store, such as in a sound room 44. For instance, the shopper may alter tone controls such as the treble and bass of the audio output with a virtual graphic equalizer (accessible at the terminal, such as via the display 2), choose a virtual listening environment (such as concert hall, small room, stage, SUV, compact car), control the volume, or select a different sound track.

For these audio demonstrations, the terminal 1 might output to reference speakers 10, which are capable of simulating the performance of a wide range of speakers to a given degree of accuracy. Although the reference speakers 10 may not replicate the performance of a real selected speaker 40 perfectly, shoppers benefit from the ease and flexibility of controlling a demonstration and product comparison from the terminal 1. The shopper can compare the performance characteristics of the selected speaker 40 with any number of additional selected speakers 40. For instance, the shopper can do a virtual A/B comparison of two selected speakers 40 (or speaker sets).

A method and system for simulating the performance characteristics of an audio device are provided in the application entitled “Virtual Speaker Demonstration System And Virtual Noise Simulation”, the disclosure of which is incorporated herein. For instance, a processor may be used to convert or condition an audio signal (e.g., a track from a popular music CD or a well-known DVD movie clip) so that the converted signal sounds or looks similar as output from a reference audio/video system as an unconverted signal would sound coming from the target audio/video system. For instance, if a target speaker is known to have a particular frequency response, an electronic sound signal may be converted so that it will cause the reference display to exhibit the same frequency response. Using these or other systems and methods for simulating a target audio or video product, a reference system may be used to simulate the performance any range of audio and video products, including speakers, subwoofers, headphones, receivers, pre-amplifiers, amplifiers, graphic equalizers, digital-to-audio converters (DACs), audio-to-digital converters (ADCs), televisions, LCD displays, front and rear-projection displays (and screens), color filters, output types (e.g., S-Video, DVI, component video, coaxial cable, and optical cable), speaker wire (e.g., 12-gauge or 16-gauge), connectors, and other products.

Similarly, the terminal 1 may simulate the performance characteristics of a selected video display device 60, such as a television or camera. Instead of using the terminal display 2, the terminal may output the video to a different display 2, such as a high quality video reference system. Again, the shopper may vary the demonstration of the product 80. For instance, the shopper may select among different video programs, vary the video connection source (S-video, component video, etc.), the contrast, the brightness, the viewer's environment (e.g., by dimming the lights near the display 2 or by simulating the performance under light or dark conditions), the resolution (e.g., number of pixels used), and technology of programming source, etc.

For example, the high quality video display device could function as a “Reference Display System” for demonstrating the simulated performance of a wide range of “Demonstration Video Devices.” For example, the Reference Display System could be used to demonstrate the performance of cameras with different pixel resolutions; performance of cameras with different lenses; performance of TV monitors by different manufacturers (e.g., Sony versus Toshiba); performance of TV monitors that are HDTV versus those that are NTSC; performance of TV monitors with plasma screens versus LCD; etc.

Therefore, the preferred terminal 1 allows the viewer to search for products, examine specification and pricing information for products, and also experience audio and video simulations of product performance. Once the consumer is satisfied, the terminal 1 can provide location information on where to go to actually see or obtain the physical product.

In one embodiment, the terminal 1 may enable the shopper to compare entire audio-video systems and combinations. For instance, the shopper may select a particular television, DVD player, preamplifier, amplifier, and speaker set. The shopper may inspect the performance of this combination and then compare it to other selected combinations.

The image of FIG. 5 may be the default image shown at the display 2 before a shopper begins to virtually shop (e.g., analogous to a homepage). The display 2 may show an actual image of the real merchant store or a computer-generated simulation of the store. The display 2 may show a variety of views of the store, including a top-down view as in FIG. 5, or another view such as the view from a downward angle. For instance, the virtual showroom may show substantially the same image as that of FIG. 1, which shows a top-down view of a floor plan of an actual merchant store. First-person views (for instance, a view from the eyes of a virtual shopper 95A), over-the-shoulder views (such as a view from over-the-shoulder of a shopper's avatar), and other third person views may also be shown. The terminal 1 may also enable the shopper to select between the different views by making an appropriate input.

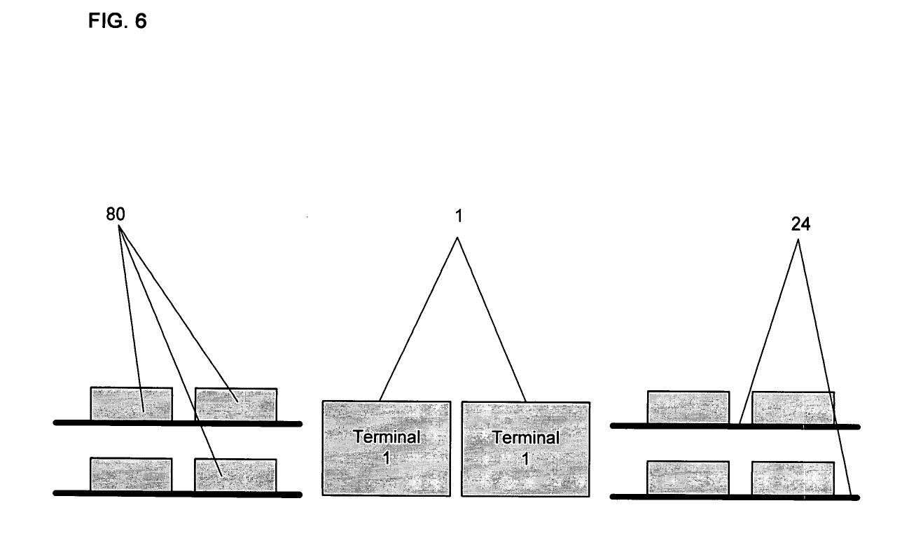

FIG. 6 illustrates a product shelf in a merchant store according to the invention. Products 80 rest on merchant shelves 24. In the present invention, terminals 1 may be positioned between shelves 24, although they may also be located anywhere else in a merchant store. For instance, a terminal 1 may be in a sound room 44 or a video room 64. There may be one or more terminals in each department 28, zone 32, or aisle 20. There may be a terminal at or near the checkout counter 36 or near the front door of the store.

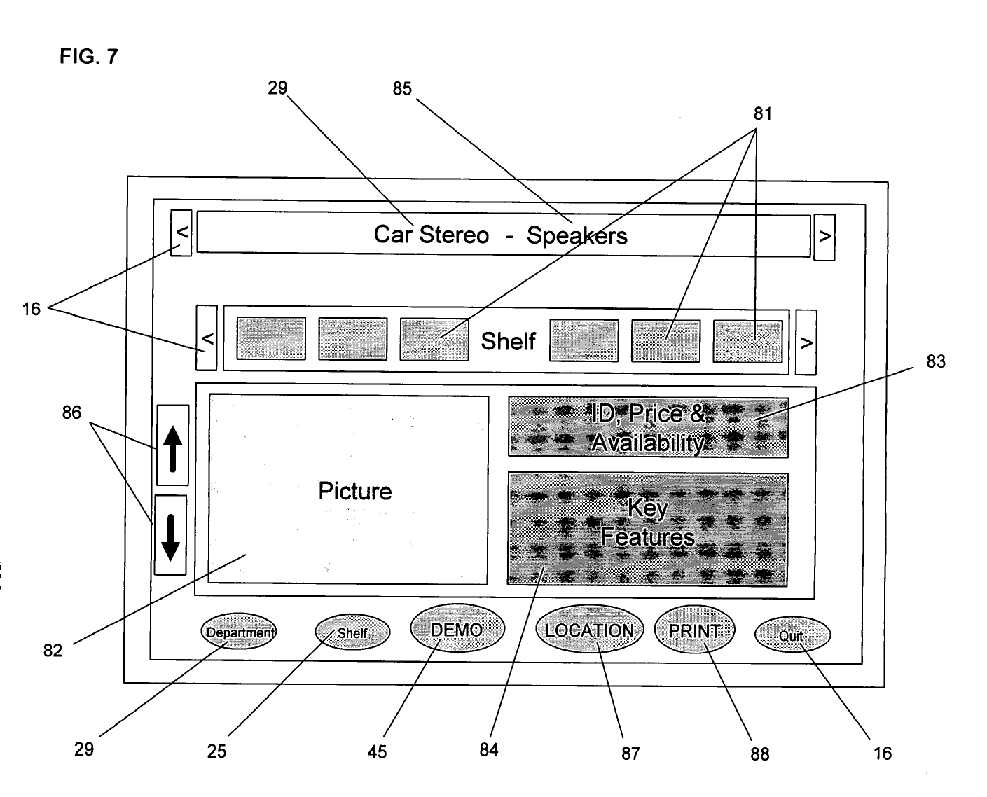

FIG. 7 illustrates a sample image displayed at the terminal 1 according to the invention. Here, the display 2 shows a shopping interface which may be displayed, for instance, after a shopper has virtually shopped through the store and selected a particular shelf and product. The interface comprises various images 82 and icons 16, 29, 81, 83, 84, 85 and virtual buttons 16, 25, 29, 45, 86, 87, 88. These images and buttons may be similar to those used on merchant websites. The shopper may interact with the interface using the shopper inputs as shown in FIG. 4, e.g., by touching the screen or using a pointing device such as a mouse.

The display 2 of FIG. 7 may show images and interfaces similar to or identical to the images and icons available on the merchant's website. For instance, shoppers may virtually shop from a home or office computer 97. This would be similar to online shopping, except that the terminal would be capable of displaying additional features as described herein, such as a map showing a directions from a particular terminal 1 to a selected product 80. When a shopper logs onto the merchant site from home, there may be an option to select the virtual shopping experience available at the terminals 1 in the real merchant store rather than use traditional online shopping methods. In this case, the shopper may start the virtual shopping experience from the virtual front door of the store, rather than from a virtual terminal 1 A.

In the exemplary interface of FIG. 7, a picture 82 of the selected product is displayed along with information about the product, such as its identification number, price, and availability 83, as well as its key features 84, which may include product specifications. Selecting the picture 82 may cause the display 2 to show additional pictures of the product, such as enlarged or expanded images (that may allow further zooming in or out) and/or views from different sides or angles. Selecting the key features 84 may cause the display 2 to show product feature information, such as specifications of the product. Selecting the ID, price, and availability 83 of a product may cause the display 2 to show additional information such as the current price, sale price, MSRP, availability in the merchant store, availability at other merchant stores, SKU, internal identification numbers, and other information discussed herein.

As shown in FIG. 7, icons of other products 81, such as images of those products, are shown to be on the selected shelf 25. In a preferred embodiment, their order as displayed on the virtual shelf 25 are identical to the order they appear on the real store shelf. Such a correlation between the virtual product shelf and the actual product shelf will make it easier for the shopper to locate different items if and when the shopper later browses through the selected aisle in the real merchant store.

By selecting one of the other products 81, a menu similar to that shown in FIG. 7 may be displayed except that the picture and information of the newly selected product 81 would replace that of the previously selected product. This selection process may repeat any number of times. The shopper may also select a next higher (or lower) model by selecting the upsell and downsell buttons 86. These buttons may cause the display 2 to show a product similar to the displayed product (e.g., from the same brand and/or product line, or possibly from another brand), except that it has a higher price and/or more desirable features (upsell) or a lower price and/or less features (downsell). The upsell and downsell buttons 86 may also be pressed any number of times, provided that additional higher- (or lower-) priced products are offered by the merchant. A similar button or set of buttons may enable the shopper to browse through similar products, such as competing products in the same price class offered by other brands.

Selecting the department button 29 may cause the display 2 to switch to a view showing the different departments in the store (or the different departments physically proximate to the selected product's department, including the selected product's department). This may be a virtual top-down view of the entire store layout, or it may be an arrangement of selectable department icons. Similarly, the shelf button 25 may cause the display 2 to switch to a view showing different shelves in the selected product's aisle. In a preferred embodiment, the display 2 would show a virtual representation of the shelves as they appear in the real store. The shopper could then select the same or a different shelf, or the shopper could select the same or a different product shown on the shelves. Departments, sections, aisles, and/or shelves may also be selected by selecting the arrow buttons 16 or the department 29 and section 85 buttons. These buttons 29, 85 may instead enable the shopper to cycle through different departments and sections rather than switching to a general department or section menu.

Selecting the demo button 45 enables the user to experience the performance of the product. If the selected product is an audio device, then the terminal may output to reference speakers an audio simulation of the performance of the selected product, as discussed herein. Similarly, if the product is a video device, the display 2 may display a video simulation of the performance of the product. Alternately, if the display 2 is not a suitable video reference device, the display 2 may cause a different reference display device to show the simulation. During the demonstration of a particular product's performance, the display 2 may show demonstration-related options to the shopper, such as volume controls, source material controls, contrast controls, graphic equalizer controls, and other controls that may be useful in evaluating the product and similar products (as discussed herein).

Selecting the location button 87 may cause the display 2 to show the location of the selected product in the store. For instance, the display 2 may show a top-down view of the store with an icon marking the product location. A different icon may mark other selected products' locations and the terminal 1 itself. By marking the terminal 1 as well as the selected product in a top-down display (e.g., a map), the shopper may determine the product's relative location from the shopper and also the best way to travel to the product. This view may resemble a schematic drawing of the store's layout.

In a preferred embodiment, upon selecting the location button 87, the display shows a first-person view of the product on the shelf and then seemlessly transitions to a top-down view of the store that shows both the product and the terminal 1 where the shopper is virtually shopping. I.e., the “virtual camera” may continuously move from in front of a product, looking at the shelf, to a view from above that includes a larger portion of the store layout. The seemless transition is effective in further enhancing the shopper's memory of the product location. Because the location information is fresh in a shopper's mind, it may not be necessary to print such a map.

Nevertheless, a print button 88 may be provided to enable the shopper to print information, such as a product receipt, a map showing the location of one or more selected products, a coupon or rebate, or a product receipt or other transaction confirmation. Other buttons and functions may also be provided.

Shoppers may end their sessions and/or log out by pressing the quit button 16.

It will be appreciated by those skilled in the art that each additional display, such as an expanded view of the product, may have the same or additional icons and buttons that allow the shopper to further “surf” through the virtual store.

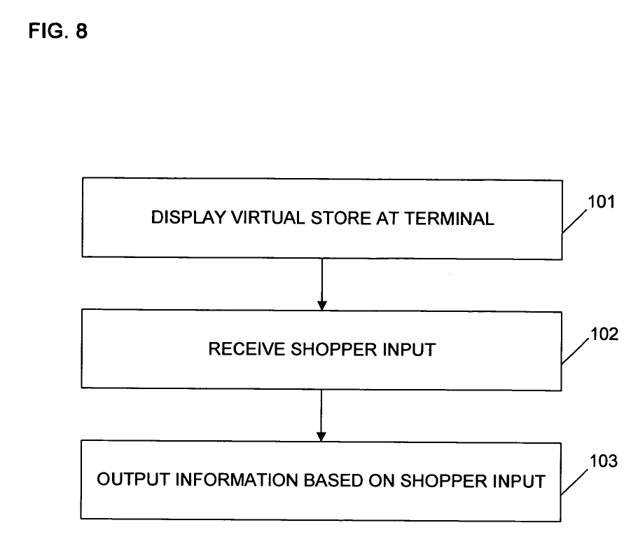

FIG. 8 shows a flow chart illustrating an exemplary method of enabling interactive shopping at a merchant terminal according to an embodiment of the invention. In step 101, the terminal 1 displays a virtual store that corresponds to the physical layout of a real merchant store. In step 102, a shopper makes inputs at the terminal 1. For instance, the shopper may select an area of the virtual store or select a “virtual shopping” button to begin a virtual shopping simulation.

The merchant may require that shoppers register with the merchant and/or set up a merchant account in order to access the virtual terminal. Such an account may require a fee, and each virtual shopping session may require that the shopper pay a fee either before, during, or after such a shopping session, or to pay a fee only to access certain virtual shopping features (such as the demonstration feature or printing feature). Such a registration process may require the shopper to input personal identification information. The shopper may then begin a virtual shopping session by making an appropriate registration input at the terminal. For instance, registered members may receive membership indicia, such as a card with a barcode or magnetic strip, and such member shoppers may input their indicia at a terminal by scanning or swiping their card at a terminal 1 input. Alternately, shoppers may simply logon by entering a user ID and password.

In step 103, the terminal 1 may display an expanded image of the selected area or an image of a virtual shopper 95A walking down aisles in the store. The shopper may make further inputs to select a product shown in the selected area or to control the movement of the virtual shopper 95A. Other inputs and outputs are described herein.

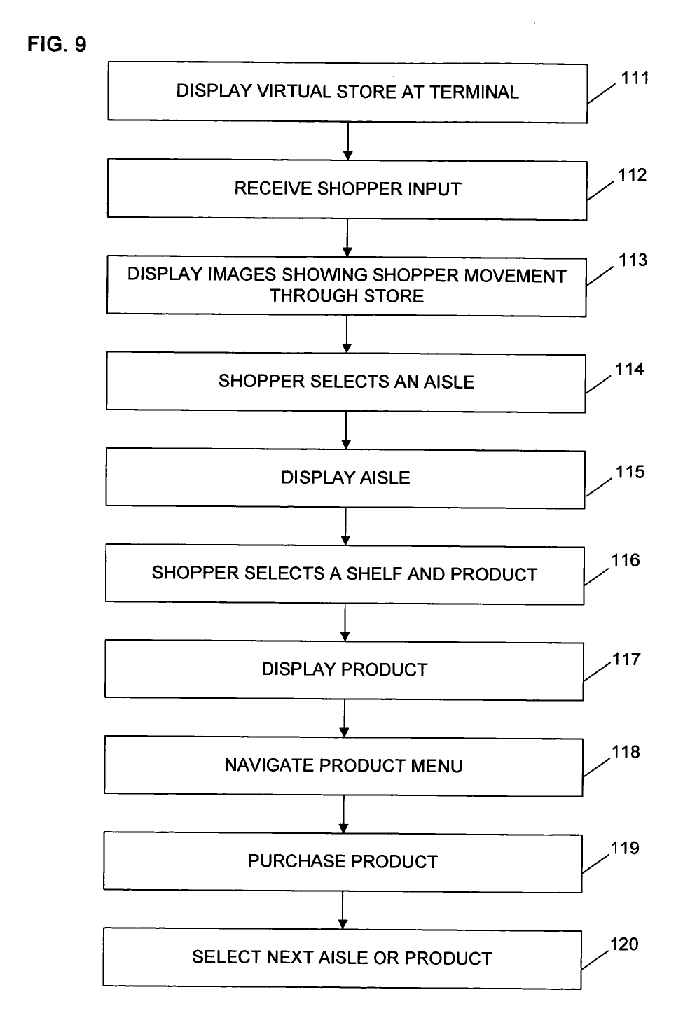

FIG. 9 shows a flow chart illustrating a method of enabling interactive shopping at a merchant terminal according to another embodiment of the invention. This method is only one particular way that a shopper might conduct a shopping session at the terminal 1. Other embodiments of the invention as described herein may be used in accomplishing this or other interactive shopping methods (e.g., the method described for FIG. 8). Any number of methods are contemplated herein, as the shopper may take any number of different actions at different times at the terminal.

In step 111, the virtual store may be displayed. This may be the default display when no shoppers are making inputs at the terminal. Other images may be used instead of an image of the virtual store, such as an outside view of the store, a merchant logo, or other store information.

In step 112, a shopper may make an input at a terminal input device. The input may comprise any shopper input at a shopper input device 5-9. For instance, the shopper may press “enter” to begin a virtual tour of the store. If the display 2 already shows an image of the store, the shopper may enter movement inputs (such as via joystick 7) to move a virtual shopper 95A through the displayed virtual store.

In step 113, the terminal 1 may display images of a virtual shopper 95A moving through the store. The real shopper may control the movement and views of the virtual shopper 95A by making appropriate inputs. For instance, the shopper may control the movement of the shopper in a manner similar to how garners control views and movement in any number of video games, such as via mouse, keyboard 5, and/or joystick 7.

In step 114, the shopper may select an aisle 20A. For instance, the shopper may touch the portion of the touch-sensitive display 2 that shows the selected aisle. Alternately, the shopper may position the shopper's virtual alter ego so that the aisle is displayed at the center of the display 2. Doing so may cause an action icon to appear, indicating that the shopper may select the aisle. The shopper may then press “enter” at the keyboard 5 or make another input to indicate the shopper's selection.

In step 115, the terminal 1 may display the selected aisle 20A. For instance, the terminal may zoom in on the image of the aisle. This may occur in a continuous fashion, as if the shopper quickly moves closer to the aisle; or it may be a discrete jump, from one view to an up-close view of the aisle. Alternately, selecting the aisle may simply cause the virtual shopper 95A to begin moving through (or toward) the selected aisle.

In step 116, the shopper may select a shelf 24A and product 80A. This may occur in a manner similar to that described above for step 115. The shopper may select a product only after browsing through a variety of shelves and products.

In step 117, the terminal 1 may display the image 80A of the selected product 80. The terminal 1 may also display any of the product information discussed herein, such as price and availability in the store. The terminal 1 may present a graphical user interface (GUI) that enables the shopper to obtain additional product information.

In step 118, the shopper may navigate a product menu. The menu may enable the shopper to obtain any information desired. For instance, the shopper may select alternate views of the product, view a technical specification, look at competing products, or view price information. The shopper may also obtain information such as product size, location in the store, price, unit price, additional product advertisement information including audio information, and information concerning other sizes or related products available in the merchant store or affiliated stores.

In step 119, the shopper may purchase the product. The shopper may log in to a special secure website for purchasing. The shopper may enter credit card or billing information at a terminal input, such as the keyboard 5. The terminal 1 may provide a purchase interface at the display 2. During the purchase process, the shopper may obtain or provide additional shopping-related information. For instance, if the shopper logs in to (or creates) an account with the merchant, the shopper may additionally view prior products purchased or selected during another shopping session, a shopper's online “shopping cart”, or personal information such as a shipping address.

In step 120, the shopper may continue shopping. For instance, the shopper may select another aisle or product or navigate the shopper's avatar to another area of the virtual showroom.

It should be noted that during the virtual shopping experience, the shopper may take any actions and store any information as in a typical online shopping experience (even though the virtual shopping does not necessarily occur over the Internet). For instance, the shopper may manage a shopping cart (add items, delete items, save items for later), manage account information (credit card information, past transactions, personal information and preferences), request to be notified of future offers or price changes for a particular product or group of products; purchase products, and otherwise communicate with the merchant through the terminal interface. In the invention, the shopper's account (such as an online account) and other information may not require accessing the Internet because such information may be stored in a database managed by the merchant. Alternately, the shopper may access information online.

According to an embodiment of the invention, information about a shopper's virtual shopping behavior can be stored and/or processed. For instance, the virtual shopping terminal may monitor and record such information as: shopper inputs, such as keypad inputs or the shopper-controlled movement of a cursor on the terminal screen; the departments, aisles, shelves, and products selected by the shopper; information requested about a particular product; the order in which the shopper makes various selections; the frequency that the shopper made a particular selection or exhibited a specific behavior; the length of time spent on any particular selection; the length of a shopper's session; or other characteristics or information related to a virtual shopping session. The terminal may also monitor and/or record such similar information on an aggregate basis (e.g., instead of or in addition to storing information associated with a particular shopper). Preferably, this information is passed to a central processor/database, which processes and stores the information.

This information may be used to determine information about a specific shopper's shopping behaviors and preferences and/or to learn about shoppers' aggregate behaviors and preferences. For instance, the merchant may determine which products, aisles, sections, and departments are the most popular (and least popular), e.g., for selection and/or demonstration. The merchant may compare virtual shopping information to actual shopping information to determine any relationship between virtual shopping and actual shopping. For instance, the merchant terminal can analyze actual sale information to determine the extent to which products selected in the virtual shopping experience were actually purchased. If the virtual shopping experience allows purchase through the virtual terminal, the merchant may also analyze sales conducted over the merchant terminal. Based on virtual shopping and actual sales information, the merchant can determine how often providing a demonstration of a product and/or printing a map to a product location in a store led to an actual purchase of the product.

If the shoppers are identified during the virtual shopping experience, such as by inputting identification information or scanning a card, the merchant may analyze shopping information according to various demographic categories. For instance, the merchant may analyze the shopping behaviors along various shopper criteria, such as age, gender, location of residence, and prior shopping history. For instance, the merchant could determine the aggregate shopping patterns during the month of December for males aged 18-25 who live in a particular area of town and have purchased over $1000 of merchandise from the store in the past six months. In one embodiment, such information could also be broken down according to shopper income and/or credit rating, if such information is available. A centralized processor may analyze such information across a variety of merchant stores. Such aggregate information could also be used to determine various shopper preferences based on merchant store location.

Merchants may also provide targeted ads to virtual shoppers. For instance, the merchant could offer a 10% discount on a more expensive television while the shopper is viewing a slightly lower priced television. The merchant may also use a shopper's personal or prior history information to provide targeted ads. For instance, if the shopper was previously shopping for an mp3 player and is now shopping for a television, the merchant may offer a discount on an mp3 player if the shopper purchases a particular television. Based on credit history or past purchase history information, the merchant may also offer attractive financing options for a particular product or group of products. These offers may be provided at the virtual terminal (e.g., by providing a particular coupon code on the screen or printing a coupon at a printer), or they may be provided in other direct mail or email advertisements.

The shopping terminal may also allow shoppers to make suggestions and requests. For instance, if a particular product or type of products is not available for the virtual demonstration feature, shoppers may request that the merchant add a demonstration feature for that product. Shoppers may also request the merchant to add particular items to store (and/or virtual store) inventory, or to make other changes in the product selection and operation of the store (and/or virtual store).

This invention provides a variety of advantages to the merchant and to shoppers. These advantages should be apparent to those skilled in the art, and some advantages are described herein. One advantage for merchants is that it reduces customer service costs. Merchants expend significant capital and labor resources to provide information to shoppers, including information regarding the location of products inside the store. By creating a new information access channel at the terminal, the invention reduces the costs of distributing such relevant product and store information to shoppers. The audio and video demonstration embodiment of the invention further reduces display costs. These costs include the cost of setting up and maintaining a demo for each demonstrated product as well as the cost of damage to that particular “demo model”, which is typically sold at a significant discount, not to mention the cost in terms of store real estate. The invention provides for a smaller number of demonstration terminals that can demonstrate the features of a large number of products, thereby reducing the need to otherwise display those products for demonstration purposes. This translates into less demonstration setups and maintenance as well as less wear and tear on a large number of products. Finally, information from monitoring virtual shopping behaviors can provide merchants with shopper behavior and preference information that is not otherwise obtainable. The merchant can use such information to further improve the physical and virtual shopping offerings and layout, as well as other store features.

It will be understood that the specific embodiment of the invention shown and described herein is exemplary only. Numerous variations, changes, substitutions and equivalents will now occur to those skilled in the art without departing from the spirit and scope of the present invention. Accordingly, it is intended that all subject matter described herein and shown in the accompanying drawings be regarded as illustrative only and not in a limiting sense and that the scope of the invention be solely determined by the appended claims.

1. An interactive electronic shopping system, comprising:
a terminal located inside a physical merchant store, the terminal comprising:
an input device for receiving shopper input; and
an output device for displaying a virtual merchant store, wherein the virtual merchant store corresponds to the physical layout of the physical merchant store.

2. The interactive shopping system of claim 1, further comprising:
a processor for generating output based on the shopper input.

3. The interactive electronic shopping system of claim 1, wherein the virtual physical layout shows the location of the terminal in the physical merchant store.

4. The interactive electronic shopping system of claim 1, wherein the virtual physical layout further comprises virtual products corresponding to products sold by the merchant in locations other than the physical merchant store where the terminal is located.

5. The interactive electronic shopping system of claim 1, wherein the virtual physical layout further comprises at least one of virtual products corresponding to products in the physical merchant store, virtual aisles corresponding to aisles in the physical merchant store, and virtual shelves corresponding to shelves in the physical merchant store.

6. The interactive electronic shopping system of claim 1, wherein the shopper input may comprise a selection of at least one of a displayed product, a displayed aisle, and a displayed shelf, wherein the selection corresponds to at least one of a product offered for sale, an aisle inside the physical merchant store, and a shelf inside the physical merchant store, respectively.

7. The interactive electronic shopping system of claim 1, wherein the shopper input comprises a selection of one or more products displayed at the terminal, wherein the terminal is configured to communicate product information of a product to the shopper based on receiving a selection of a product from the shopper, and wherein the product information may comprise at least one of an audio and video representation of at least one of a price, a brand, a description of a product or product feature, a technical specification, and an image of a product.

8. The interactive electronic shopping system of claim 1, wherein the terminal is configured to display graphical information indicating a product location inside the physical merchant store of a shopper-selected product in relation to the location of the terminal inside the physical merchant store.

9. The interactive electronic shopping system of claim 1, wherein the display of the virtual merchant store changes to correspond to shopping location input information received from the shopper so that the display shows images of what the shopper would see if the shopper were changing locations within the physical merchant store.

10. The interactive electronic shopping system of claim 1, further comprising a reference output device configured to simulate the performance characteristics of a plurality of products, wherein the plurality of products comprises at least one of a plurality of speakers, a plurality of video display devices, and a plurality of video capture devices.

11. The interactive electronic shopping system of claim 12, wherein the input device is configured to receive a shopper selection of product demonstration characteristic, wherein the product demonstration characteristic comprises at least one of a camera resolution, lighting condition, demonstration space, environmental condition, preamplifier model, amplifier model, receiver model, speaker model, television model, projector model, screen type or model, graphic equalizer setting, speaker configuration, one or more speaker locations, and a sound tone preference.

12. The electronic shopping system of claim 1, wherein said input device is configured to receive purchase and billing information associated with the purchase of a product selected at the terminal by the shopper.

13. The electronic shopping system of claim 1, wherein the terminal is electronically coupled to a database configured to store at least one of shopper input information and information relating to products selected at the terminal by a shopper.

14. The electronic shopping system of claim 1, wherein the terminal is electronically coupled to a database configured to store shopping information in a shopper's online account based on shopper input information received at the terminal, and wherein the shopping information comprises product information and location information identifying the product's location in the physical merchant store.

15. The electronic shopping system of claim 1, further comprising:
a printer, wherein the printer is configured to print location information indicative of a location of the terminal in relation to a location of one or more selected products in the physical merchant store.

16. The electronic shopping system of claim 1, further comprising:
a transmitter for transmitting product information and product location information to a handheld display device of a shopper.

17. A method of using the electronic shopping system of claim 1, comprising:
logging a remote shopper onto the terminal via the Internet, wherein the remote shopper is outside the physical merchant store; and
transmitting shopping information to the remote shopper.

18. A method of displaying a virtual store, comprising:
displaying a virtual physical layout of a physical merchant store at a display terminal located inside the physical merchant store, wherein the virtual physical layout corresponds to the real physical layout of the physical merchant store;
receiving input from a shopper at the display terminal; and
outputting shopping information at the display terminal, wherein the shopping information is based on the input.

19. The method of claim 18, wherein the virtual physical layout comprises a virtual terminal corresponding to the terminal.

20. The method of claim 18, wherein the virtual physical layout comprises one or more virtual aisles corresponding to one or more physical aisles in the physical merchant store.

21. The method of claim 20, further comprising
receiving from the shopper a selection of at least one of a virtual aisle and a virtual shelf.

22. The method of claim 18, wherein the virtual physical layout comprises virtual products corresponding to physical products in the physical merchant store.

23. The method of claim 18, further comprising:
receiving at the terminal a selection of at least one of a virtual product and a virtual location, wherein the at least one of a virtual product and virtual location corresponds to at least one of a physical product and physical location inside the physical merchant store, respectively.

24. The method of claim 26, further comprising:
displaying a substantially continuous stream of images showing virtual movement from one location in the virtual store to the selected location.

25. The method of claim 18, further comprising:
outputting advertising information at the terminal.

26. The method of claim 18, wherein the input comprises information about movement of inside the virtual store, further comprising:
based on the movement input, displaying one or more images corresponding to what the shopper would see were the shopper to move through the physical merchant store in a manner corresponding to the movement input.

27. The method of claim 18, further comprising:
displaying the virtual terminal and a selected product in a single output image, wherein the output image indicates information about the relative locations of the terminal and the selected product.

28. The method of claim 18, further comprising:
outputting directions, wherein the directions comprise directions from the terminal to the selected location, wherein said outputting action comprises at least one of displaying the directions and printing the directions.

29. The method of claim 18, further comprising:
receiving a request for information about a selected product from a shopper; and
communicating information about the selected product to the shopper.

30. The method of claim 18, further comprising:
displaying a plurality of virtual products corresponding to a plurality of physical products offered for sale by the merchant;
receiving a selection of one of the plurality of virtual products corresponding to one of the plurality of physical products; and
outputting at least one of sound and video at a reference output device, wherein the at least one of sound and video simulates performance characteristics of the selected one of the plurality of physical products.

31. The method of claim 30, wherein the product comprises at least one of an audio output device, an audio recording device, a video recording device, and a video display device.

32. The method of claim 30, further comprising:
prior to the outputting action, receiving a shopper selection of at least one of: a camera resolution, lighting conditions, a demonstration space, environmental conditions, a preamplifier, an amplifier, a receiver, a speaker configuration, one or more speaker locations, and bass and treble preferences.

33. The method of claim 18, further comprising:
receiving at the terminal purchase and billing information relating to a shopper purchase of a selected product.

34. The method of claim 18, further comprising:
storing in a shopper account product information for one or more products selected by the shopper.

35. The method of claim 18, further comprising:
downloading shopper account information via the Internet; and
passing the shopper account information to the shopper.

36. The method of claim 18, further comprising:
based on the input, passing shopping information to a personal wireless device associated with the shopper, wherein the personal wireless device comprises at least one of a wireless phone, a PDA, a portable gaming system, and an mp3 player.

37. The method of claim 18, further comprising:
processing the input; and
determining shopper behavior information based on the input.

38. An interactive electronic shopping system, comprising:
a central database to store digital signals representing images of at least a portion of a shopping facility;
a computer terminal at the shopping facility comprising a display device configured to display images of the shopping facility;
a communication link between the central database and the computer terminal; and
a control interface connected to the computer terminal to enable a shopper to control a display of the images of the shopping facility.

39. The interactive electronic shopping system of claim 38, further comprising:
a digital camera to digitize the at least a portion of the shopping facility into the digital signals.

40. A method of displaying a virtual store corresponding to a real store, comprising:
displaying at a display terminal a virtual physical layout of a physical merchant store at a display terminal located inside the physical merchant store, wherein the virtual physical layout corresponds to the real physical layout of the physical merchant store, and wherein the virtual physical layout comprises a virtual terminal corresponding to the terminal;
receiving shopper browsing information from a shopper at an input device electronically coupled to the display terminal, wherein the shopper browsing information is associated with virtual movement through the virtual physical layout corresponding to movement through the physical merchant store;
based on the shopping information, displaying at the display terminal a substantially continuous stream of images showing virtual movement from one location in the virtual store corresponding to a physical location in the physical merchant store to another location in the virtual store corresponding to another location in the physical merchant store;
displaying at the display terminal a plurality of virtual products associated with a virtual location in the virtual physical layout corresponding, respectively, to a plurality of physical products located in the physical merchant store;
receiving a selection of a specific one of the plurality of products by the shopper;
passing product information associated with the selected product to the shopper; and
passing product location information indicative of a location of the selected specific product in the physical merchant store to the shopper.
